(19) United States
(12) Patent Application Publication
(10) Pub. No.: US 2025/0043707 A1
(43) Pub. Date: Feb. 6, 2025

(54) METHOD AND APPARATUS FOR CARBON CAPTURE IN AN EXHAUST SYSTEM

(71) Applicant: Faurecia Emissions Control Technologies, USA, LLC, Columbus, IN (US)

(72) Inventors: Jerome Hornback, Indianapolis, IN (US); Ryan Market, Rushville, IN (US); Jeffery Prairie, Franklin, IN (US); Randall Cvelbar, Columbus, IN (US); Edward Kinnaird, Columbus, IN (US); Scott Bottoms, Greensburg, IN (US); Anthony Burnett, Freetown, IN (US); Robert Nash, Martinsville, IN (US); Mark Lambrecht, Columbus, IN (US)

(21) Appl. No.: 18/229,216

(22) Filed: Aug. 2, 2023

(51) Int. Cl. F01N 3/08; F01N 13/08

(52) U.S. Cl. CPC F01N 3/0857; F01N 3/0871; F01N 13/08; F01N 2240/16; F01N 2240/20; F01N 2570/10

(57) ABSTRACT

A method and apparatus includes a housing defining an internal cavity, wherein the housing includes at least a first exhaust gas inlet for exhaust gas at a first temperature and a second exhaust gas inlet for exhaust gas at a second temperature greater than the first temperature. The housing further includes at least a first outlet to atmosphere and a second outlet to at least one storage component. At least one heating element is positioned within the internal cavity. Adsorption material is located within the internal cavity, and at least one flow guide directs exhaust gas through the adsorption material from the first exhaust gas inlet to the first outlet.

### TECHNICAL FIELD

The subject disclosure generally relates to method and apparatus for capturing carbon dioxide (CO₂) in a vehicle exhaust system.

### BACKGROUND OF THE INVENTION

Reducing CO₂ emissions is an ever increasing challenge. Current systems for capturing CO₂ on board a vehicle can be inefficient and expensive.

### SUMMARY OF THE INVENTION

In one exemplary embodiment, an apparatus includes: a housing defining an internal cavity, wherein the housing includes at least a first exhaust gas inlet for exhaust gas at a first temperature and a second exhaust gas inlet for exhaust gas at a second temperature greater than the first temperature, and wherein the housing includes at least a first outlet to atmosphere and a second outlet to at least one storage component; at least one heating element positioned within the internal cavity; adsorption material located within the internal cavity; and at least one flow guide to direct exhaust gas through the adsorption material from the first exhaust gas inlet to the first outlet.

In another embodiment according to the previous embodiment, the at least one flow guide comprises a first flow guide at the first exhaust gas inlet and a second flow guide separate from the first flow guide and located at the first outlet.

In another embodiment according to any of the previous embodiments, the at least one flow guide comprises a curved outer surface spaced apart from and facing the first exhaust gas inlet, the curved outer surface directing exhaust gas flow outwardly toward an inner surface of the housing.

In another embodiment according to any of the previous embodiments, exhaust gas flows from the first exhaust gas inlet, through the adsorption material to collect CO₂, and then out the first outlet.

In another embodiment according to any of the previous embodiments, the apparatus further includes a plurality of baffle plates spaced apart from each other within the internal cavity in a stacked relationship, wherein outer end baffle plates of the baffle plates have openings smaller in size than openings in baffle plates located between the outer end baffle plates.

In another embodiment according to any of the previous embodiments, the at least one heating element is heated via a heat source to heat the adsorption material to extract CO₂ from the adsorption material, and wherein the CO₂ is directed through the second outlet to the at least one storage component, and wherein the heat source comprises exhaust gas at the second temperature or an electrical heat source.

In another embodiment according to any of the previous embodiments, the apparatus further includes one or more heaters selectively activated to heat exhaust gas prior to entering the housing via the second exhaust gas inlet.

In another embodiment according to any of the previous embodiments, the adsorption material comprises zeolite.

In another embodiment according to any of the previous embodiments, the at least one heating element comprises a plurality of tubes that receive exhaust gas from the second exhaust gas inlet and direct exhaust gas through a third outlet from the housing to a cooling source.

In another embodiment according to any of the previous embodiments, the at least one heating element comprises a plurality of rods or fingers having solid bodies with a plurality of through holes.

In another embodiment according to any of the previous embodiments, the at least one heating element comprises one or more electrically heated plates or augers.

In another embodiment according to any of the previous embodiments, the at least one heating element comprises a center tube having a tube inlet in communication with the second exhaust gas inlet and a tube outlet that directs exhaust gas through a third outlet from the housing to a cooling source, and wherein the center tube includes a plurality of fins, splines, or augers formed on an outer peripheral surface of the center tube and along a length of the center tube.

In another embodiment according to any of the previous embodiments, the apparatus further includes at least one heater selectively heating the exhaust gas prior to entering the housing via the second exhaust gas inlet.

In another embodiment according to any of the previous embodiments, the housing includes an outer peripheral wall extending between first and second end caps, and including: at least one opening in the outer peripheral wall to access the internal cavity; and a cap that is selectively attachable to the housing to cover the at least one opening.

In one exemplary embodiment, an apparatus includes: a housing defining an internal cavity, wherein the housing includes at least a first exhaust gas inlet for exhaust gas at a first temperature and a second exhaust gas inlet for exhaust gas at a second temperature greater than the first temperature, and wherein the housing includes at least a first outlet to atmosphere, a second outlet to at least one storage component, and a third outlet to a cooling source; a plurality of heating elements positioned within the internal cavity; adsorption material located within the internal cavity and in contact with the plurality of heating elements; at least one flow guide to direct exhaust gas through the adsorption material from the first exhaust gas inlet to the first outlet; and a controller that is configured to operate amongst a plurality of modes comprising at least: a first mode wherein exhaust gas flows from the first exhaust gas inlet, through the adsorption material to collect CO₂, and then out the first outlet; and a second mode wherein the plurality of heating elements are heated via a heat source to heat the adsorption material to extract CO₂ from the adsorption material, and wherein the CO₂ is directed through the second outlet to the at least one storage component.

In another embodiment according to any of the previous embodiments, the second exhaust gas inlet, the second outlet, and the third outlet are closed during the first mode; and the first exhaust gas inlet and the first outlet are closed during the second mode.

In another embodiment according to any of the previous embodiments, the apparatus further includes at least one heater selectively activated during the second mode to heat exhaust gas prior to entering the housing via the second exhaust gas inlet.

In another embodiment according to any of the previous embodiments, the plurality of heating elements comprise a plurality of tubes, and wherein the heat source comprises exhaust gas flowing from the second exhaust gas inlet, through the plurality of tubes, and out the third outlet while the CO₂ is extracted from the adsorption material and directed to the second outlet.

In another embodiment according to any of the previous embodiments, the at least one flow guide comprises a first flow guide and a second flow guide separate from the first flow guide, and wherein: the first flow guide comprises a curved outer surface spaced apart from and facing the first exhaust gas inlet, the curved outer surface directing exhaust gas flow outwardly toward an inner surface of the housing and into the adsorption material; and the second flow guide comprises a curved outer surface spaced apart from and facing the first outlet, the curved outer surface directing exhaust gas flow outwardly away from the adsorption material and toward the first outlet.

In one exemplary embodiment, a method includes: operating a carbon capture system that is operable between at least a first mode and a second mode; when operating in the first mode, directing cooled exhaust gas through adsorption material located within an internal cavity of housing to collect CO₂ prior to exhaust gas exiting to atmosphere; and when operating in the second mode, heating the adsorption material via an exhaust gas heat source to extract CO₂ from the adsorption material, directing the CO₂ to at least one storage component, and directing exhaust gas out of the housing to another circuit.

These and other features may be best understood from the following drawings and specification.

### BRIEF DESCRIPTION OF THE DRAWINGS

FIG. 1 is a perspective view of a carbon capture tank according to one example of the disclosure.

FIG. 2 is a side view of the carbon capture tank of FIG. 1.

FIG. 3 is a view similar to FIG. 2 but with a portion of an outer shell removed.

FIG. 4 is a view similar to FIG. 3 and showing a first operational mode.

FIG. 5 is a view similar to FIG. 3 and showing a second operational mode.

FIG. 6 is a perspective view of the carbon capture tank of FIG. 3 with the addition of a side-mounted cap.

FIG. 7 is a schematic view of one example of a heating element used within the carbon capture tank.

FIG. 8 is a schematic view of another example of a heating element.

FIG. 9 is a schematic view of another example of a heating element.

FIG. 10 is a schematic view of another example of a heating element.

FIG. 11 is a schematic view of another example of a heating element.

### DETAILED DESCRIPTION

The disclosure is directed to a carbon capture system that extracts carbon dioxide CO₂ from exhaust gas in a vehicle exhaust system prior to the exhaust gas being expelled to atmosphere. The carbon capture system also takes the extracted carbon dioxide CO₂ and stores it in storage containers.

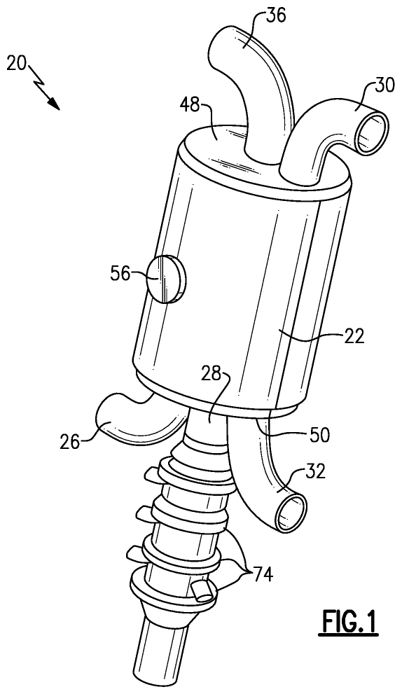

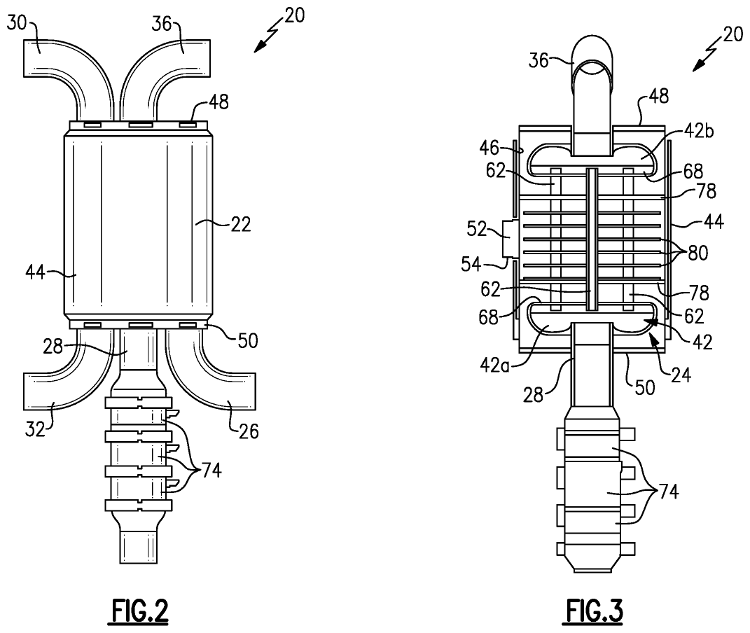

FIGS. 1-2 shows a carbon capture tank assembly 20 including an outer shell or housing 22 defining an internal cavity 24 (FIG. 3). In one example, the housing 22 includes at least a first exhaust gas inlet 26 for exhaust gas at a first temperature and a second exhaust gas inlet 28 for exhaust gas at a second temperature greater than the first temperature. In this example, the housing 22 further includes at least a first outlet 30 to atmosphere, a second outlet 32 to at least one storage component 34, and a third outlet 36 to a cooling source 38.

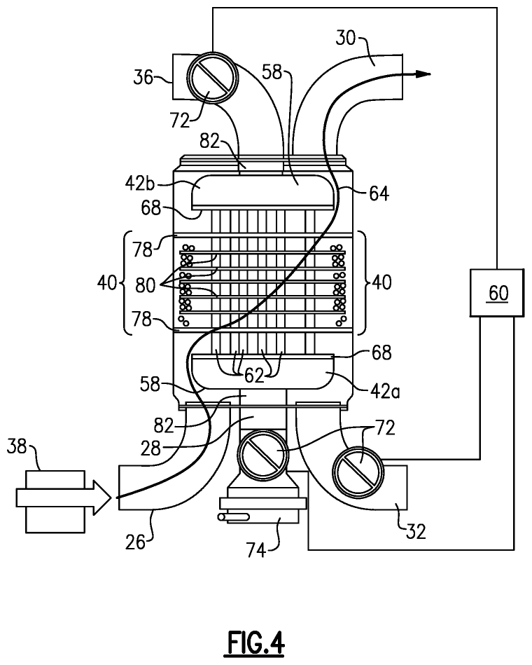

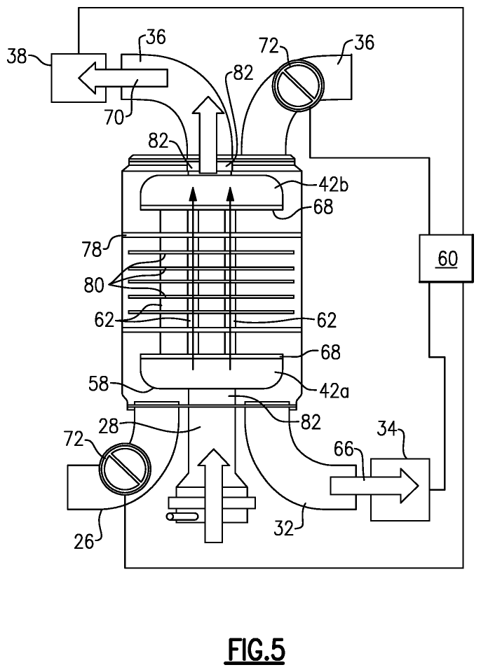

Adsorption material 40 is located within the internal cavity 24 as shown in FIG. 4. Specifically, the adsorption material 40 is located within an adsorption material chamber within the internal cavity 24 as shown in FIG. 6. The adsorption material 40 is shown schematically in FIG. 4, and is shown in only small portions within the internal cavity 24 for purposes of clarity; however, it should be understood that the adsorption material 40 would fill an entire fill space as designated within the adsorption material chamber. Any type of adsorption material 40 can be used, such as Zeolite, magnesium oxide or other similar materials, for example. Additionally, the adsorption material 40 can take any form such as pellets, discs, foam, etc., for example, and should provide a high surface area for adsorption purposes.

The housing 22 of the carbon capture tank assembly 20 comprises an outer surface 44 and an inner surface 46 that defines the internal cavity 24. The outer surface 44 and the inner surface 46 extend between first 48 and second 50 end caps that enclose the internal cavity 24. In one example, the first exhaust gas inlet 26 and second exhaust gas inlet 28 comprise tubes that extend outwardly from the second end cap 50. In this example, the second outlet 32 also comprises a tube that extends outwardly from the second end cap 50. In one example, the first outlet 30 and the third outlet 36 comprise tubes that extend outwardly of the first end cap 48.

In one example, an opening 52 (FIG. 3) is formed in the outer surface 44 of the housing 22 to extend from the outer surface 44 to the inner surface 46, i.e. through a wall thickness of the housing 22. In one example, a boss 54 extends outwardly of the outer surface 44 of the housing 22 and surrounds the opening 52. The opening 52 provides access to the internal cavity 24 for selectively removing or adding adsorption material 40 as needed. As shown in one example in FIG. 6, a cap 56 is attached to the boss 54 to cover the opening 52 once the cavity 24 has been filled to a desired level.

In one example, the opening 52 is formed in a side surface of the housing 22. i.e. a surface that is spaced from the first 48 and second 50 end caps. This side-mounted cap configuration facilitates access to the internal cavity 24 without having to detach any of the tubes associated with the end caps 48, 50.

The carbon capture tank assembly 20 also includes at least one flow guide 42 to direct exhaust gas through the adsorption material 40 from the first exhaust gas inlet 26 to the first outlet 30 as shown in FIG. 4. In one example, the at least one flow guide 42 comprises a first flow guide 42a and a second flow guide 42b separate from the first flow guide 42a. In one example, each flow guide 42a, 42b comprises a curved outer surface 58. The curved outer surface 58 of the first flow guide 42a is spaced apart from, and faces, the first exhaust gas inlet 26. The curved outer surface 58 of the first flow guide 42a directs exhaust gas flow outwardly toward the inner surface 46 of the housing 22 and into the adsorption material 40. The curved outer surface 58 of the second flow guide 42b is spaced apart from, and faces, the first outlet 30. The curved outer surface 58 of the second flow guide 42b directs exhaust gas flow outwardly away from the adsorption material 40 and toward the first outlet 30

A controller 60 is configured to operate carbon capture tank assembly 20 amongst a plurality of modes comprising at least a first mode (FIG. 4) and a second mode (FIG. 5). In one example, one or more heating elements 62 are positioned within the internal cavity 24. In one example, at least some of the adsorption material 40 is in direct contact with the plurality of heating elements 62.

As shown in FIG. 4, in the first mode, exhaust gas flows from the first exhaust gas inlet 26, through the adsorption material 40 to collect CO₂, and then flows out the first outlet 30 to atmosphere as indicated at 64. The exhaust gas exits the first outlet 30 without any, or with very little, CO₂ being expelled to atmosphere. As shown in FIG. 5, in the second mode, the heating elements 62 are heated via a heat source to heat the adsorption material 40 to a temperature where CO₂ can be extracted from the adsorption material 40. The extracted CO₂ is then directed through the second outlet 32 to the at least one storage component 34 as indicated at 66. In one example, the storage component 34 comprises one or more storage tanks that are on board the vehicle.

In one example, the first mode is active during normal operation of the vehicle. In one example, the controller 60 activates the second mode as needed to extract CO₂ from the adsorption material 40. This second mode can be activated at certain time intervals, during maintenance operations, or when the adsorption material 40 is no longer capable of continuing to adsorb CO₂, for example.

In the example shown in FIG. 5, the heating elements 62 comprise a plurality of hollow tubes that extend between the first flow guide 42a and the second flow guide 42b. In one example, each of the flow guides 42a, 42b comprises a bowl-shaped portion defined by the curved surface 58 and having an open end of the bowl portion closed off with a flat plate 68. The bowl-shaped portions comprise internal collection chambers that are enclosed by the plates 68. Each plate 68 has an opening for each tubular heating element 62. First ends of the tubular heating elements 62 are received within openings in the plate 68 for the first flow guide 42a, and second ends of the tubular heating elements 62 are received within openings in the plate 68 for the second flow guide 42b. Thus, the tubular heating elements 62 fluidly connect the internal collection chamber of the first flow guide 42a with the internal collection chamber of the second flow guide 42b. The number and size of the tubular heating elements 62 can be varied as needed to provide a desired heating effect.

In one example, the heat source used to heat the heating elements 62 comprises exhaust gas flowing from the second exhaust gas inlet 28, into the collection chamber of the first flow guide 42a, through the plurality of hollow tubular heating elements 62, and out the third outlet 36 as shown at 70 in FIG. 5. The heating elements 62 heat the adsorption material 40 to extract the CO₂ such that it can subsequently be directed to the second outlet 32.

In one example, a plurality of closure members 72 are used to control flow during operation of the different modes. In one example, the closure members 72 comprise valves or other similar structures. The controller 60 controls the closure members 72 to perform the various modes. In one example, the controller 60 activates the closure members 72 such that the second exhaust gas inlet 28, the second outlet 32, and the third outlet 36 are closed during the first mode (see FIG. 4). In one example, the controller 60 activates the closure members 72 such that the first exhaust gas inlet 26 and the first outlet 30 are closed during the second mode (see FIG. 5).

The controller 60 can include one or more processors, memories, and one or more input and/or output (I/O) device interface(s) that are communicatively coupled via a local interface. The local interface can include, for example but not limited to, one or more buses and/or other wired or wireless connections. The controller 60 may be a hardware device for executing software, particularly software stored in memory. The controller 60 can be a custom made or commercially available processor, a central processing unit (CPU), an auxiliary processor among several processors associated with the computing device, a semiconductor based microprocessor (in the form of a microchip or chip set) or generally any device for executing software instructions. The controller 60 can be configured to execute software stored within the memory, to communicate data to and from the memory, and to generally control operations of the computing device pursuant to the software. Software in memory, in whole or in part, is read by the processor and executed to perform the desired mode. Those skilled in the art who have the benefit of this description will be able to provide a controller or controllers that are capable of controlling the carbon capture system as described herein.

In one example, the first exhaust gas inlet 26 is for exhaust gas at a first temperature and the second exhaust gas inlet 28 is for exhaust gas at a second temperature that is greater than the first temperature. In one example, the first temperature is less than or equal to 250 degrees fahrenheit; however, this temperature threshold can be varied as needed dependent upon the absorption material. This lower temperature exhaust gas at the first exhaust gas inlet 26 allows the CO₂ to be removed from the exhaust gas stream and absorbed into the adsorption material 40 as shown at 64 in FIG. 4. In one example, the cooling source 38 that cools the exhaust gas for the first exhaust gas inlet 26 comprises a heat exchanger or other similar structure.

In one example, the second temperature of the exhaust gas at the second exhaust gas inlet 28 is higher than 250 degrees fahrenheit, for example in an exhaust gas system operating range of 400-500 degrees fahrenheit or higher. This higher temperature exhaust gas at the second exhaust gas inlet 28 is used to heat the adsorption material 40 to a temperature level such that the CO₂ can be extracted from the adsorption material 40 and directed to a storage component 34. Once the CO₂ is extracted, the adsorption material 40 material is ready to absorb CO₂ again.

In one example, at least one heater 74 is selectively activated during the second mode to heat exhaust gas prior to entering the housing 22 via the second exhaust gas inlet 28. The heater 74 is used to heat the exhaust gas to the desired temperature level for CO₂ extraction. In the example shown in FIGS. 1-3, three heaters 74 are used to heat the exhaust gas prior to entering the housing 22. A single heater or any number of heaters could be used, and any type of heater can be used to heat the exhaust gas. Those skilled in the art who have the benefit of this description will be able to determine the number and types of heaters that would be required to heat the exhaust gas to the desired temperature level for CO₂ extraction.

In one example, the carbon capture tank assembly 20 includes one or more heat transfer members 78, 80. In the example shown in FIG. 3-6, the heat transfer members 78, 80 comprise a plurality of baffle plates that are spaced apart from each other along a center axis of the housing 22. In one example, the plates are perforated or have a plurality of openings extending through a thickness of the plates. In one example, the plates have openings of different sizes. For example, a first plate 78 can have holes of a first size and a second plate 80 can have holes of a second size greater than the first size.

FIG. 6 shows that the first plates 78 comprise outer end plates of the stack of plates within the internal cavity 24. The second plates 80 are located axially between the end plates 78. The area between the first plates 78 comprises the adsorption material chamber. In one example, the size of the holes or openings in the end plates 78 are small enough such that the adsorption material particles cannot fall through the holes. The holes in the second plates are bigger such that the adsorption material particles can fall through the holes. This allows the adsorption material particles to fill up the entire fill area defined between the two end plates 78. In this example, the cap 56 and fill opening 52 are positioned on the outer housing 22 at a location that is between the end plates 78. This further facilitates a quick and easy filling process.

In one example, the plates 78, 80 each include openings to receive the tubular heating elements 62. The plates 78, 80 can be directly attached to the tubular heating elements 62 and/or to the inner surface 46 of the housing 22. The ends of the tubular elements 62 are attached to the plates 68 of the flow guides 42a, 42b. In one example, the flow guides 42a, 42b also each include a tubular connector portion 82. The tubular connector portion 82 of the first flow guide 42a connects to the tubular portion of the second inlet 28, and the tubular connector portion 82 of the second flow guide 42b connects to the tubular portion of the third outlet 36.

As discussed above, the heat source used to heat the heating elements 62 can be exhaust gas. In another example, the heat source comprises an electrical heat source. FIGS. 7-11 show different examples of heating elements 62. The heating elements 62 are used to increase heat transfer to the adsorption material 40 to more quickly extract the CO₂.

FIG. 7 shows an example where the tubular heating elements of FIG. 6 are replaced by pillars 84 having a plurality of fins 86 to increase heat transfer surface area. The pillars 84 may also include thru-holes 88 to further facilitate heat transfer to the adsorption material 40. The exhaust gas flows into the second exhaust gas inlet 28, through the internal cavity 24 to heat the pillars 84 and the adsorption material 40 to extract the CO₂, and then exits via the third outlet 36.

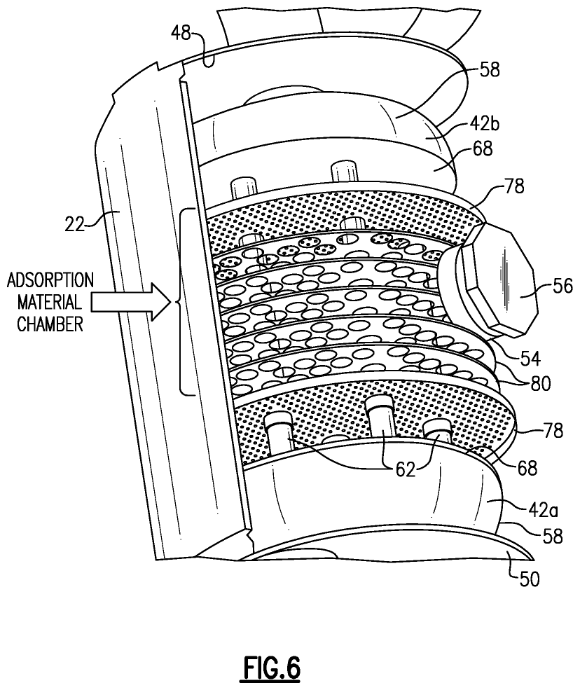

FIG. 8 shows an example where the heating members 62 comprise a plurality of electrically heated elements 90 that comprise plates positioned within the internal cavity 24. In one example, the electrically heated elements 90 are spaced apart from each other and staggered relative to each other along a length of the housing 22. The electrically heated elements 90 are also positioned at an angle relative to the inner surface 46 of the housing 22. This further facilitates filling and removing the adsorption material 40. The exhaust gas flows into the second exhaust gas inlet 28, through the internal cavity 24, where the electrically heated elements 90 further heat the exhaust gas and the adsorption material 40 to extract the CO₂. The exhaust gas then exits via the third outlet 36.

FIG. 9 shows an example similar to FIG. 8 but uses electrically heated auger elements 92 instead of plates.

In one example, the adsorption material 40 can also have a coating material to further enhance electrical conductivity.

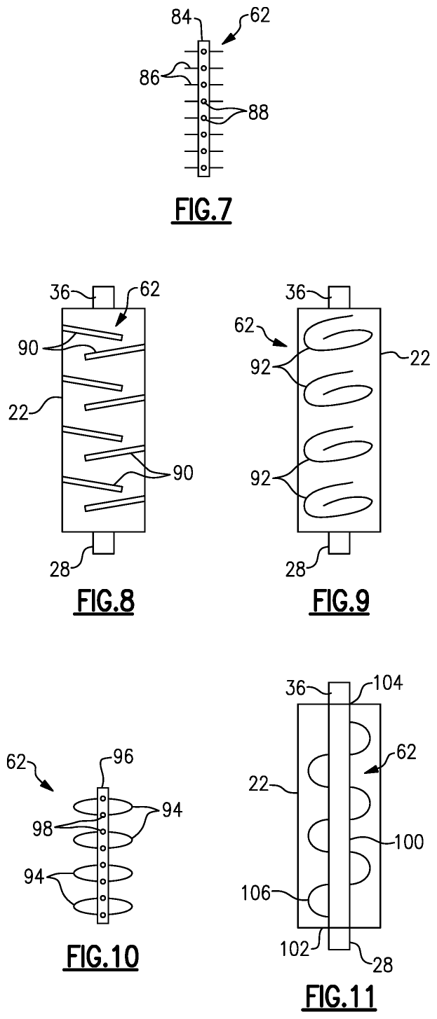

FIG. 10 shows an example similar to FIG. 7 but which uses fingers 94. A center portion 96 comprises a solid body with thru-holes 98. The fingers 94 extend outwardly of the center portion 96 to increase heat transfer surface area.

FIG. 11 shows an example where the heating element 62 comprises a center tube 100 having a tube inlet 102 in communication with the second exhaust gas inlet 28 and a tube outlet 104 that directs exhaust gas through the third outlet 36 from the housing 22 to the cooling source 38. The center tube 100 includes heat transfer members 106, e.g., a plurality of fins, splines, or augers, which are formed on an outer peripheral surface of the central tube 100 and extend along a length of the central tube 100.

The subject disclosure provides a carbon capture tank assembly 20 that is lighter in weight and easier/quicker to assemble as compared to traditional configurations. The subject carbon capture tank assembly 20 also has a faster thermal swing and a more efficient thermal transfer compared to existing designs.

Although an embodiment of this invention has been disclosed, a worker of ordinary skill in this art would recognize that certain modifications would come within the scope of this invention. For that reason, the following claims should be studied to determine the true scope and content of this invention.

1. An apparatus comprising:
a housing defining an internal cavity, wherein the housing includes at least a first exhaust gas inlet for exhaust gas at a first temperature and a second exhaust gas inlet for exhaust gas at a second temperature greater than the first temperature, and wherein the housing includes at least a first outlet to atmosphere and a second outlet to at least one storage component;
at least one heating element positioned within the internal cavity;
adsorption material located within the internal cavity; and
at least one flow guide to direct exhaust gas through the adsorption material from the first exhaust gas inlet to the first outlet.

2. The apparatus according to claim 1, wherein the at least one flow guide comprises a first flow guide at the first exhaust gas inlet and a second flow guide separate from the first flow guide and located at the first outlet.

3. The apparatus according to claim 1, wherein the at least one flow guide comprises a curved outer surface spaced apart from and facing the first exhaust gas inlet, the curved outer surface directing exhaust gas flow outwardly toward an inner surface of the housing.

4. The apparatus according to claim 1, wherein exhaust gas flows from the first exhaust gas inlet, through the adsorption material to collect CO₂, and then out the first outlet.

5. The apparatus according to claim 1, including a plurality of baffle plates spaced apart from each other within the internal cavity in a stacked relationship, wherein outer end baffle plates of the baffle plates have openings smaller in size than openings in baffle plates located between the outer end baffle plates.

6. The apparatus according to claim 1, wherein the at least one heating element is heated via a heat source to heat the adsorption material to extract CO₂ from the adsorption material, and wherein the CO₂ is directed through the second outlet to the at least one storage component, and wherein the heat source comprises exhaust gas at the second temperature or an electrical heat source.

7. The apparatus according to claim 6, including one or more heaters selectively activated to heat exhaust gas prior to entering the housing via the second exhaust gas inlet.

8. The apparatus according to claim 1, wherein the adsorption material comprises zeolite.

9. The apparatus according to claim 1, wherein the at least one heating element comprises a plurality of tubes that receive exhaust gas from the second exhaust gas inlet and direct exhaust gas through a third outlet from the housing to a cooling source.

10. The apparatus according to claim 1, wherein the at least one heating element comprises a plurality of rods or fingers having solid bodies with a plurality of through holes.

11. The apparatus according to claim 1, wherein the at least one heating element comprises one or more electrically heated plates or augers.

12. The apparatus according to claim 1, wherein the at least one heating element comprises a center tube having a tube inlet in communication with the second exhaust gas inlet and a tube outlet that directs exhaust gas through a third outlet from the housing to a cooling source, and wherein the center tube includes a plurality of fins, splines, or augers formed on an outer peripheral surface of the center tube and along a length of the center tube.

13. The apparatus according to claim 1, including at least one heater selectively heating the exhaust gas prior to entering the housing via the second exhaust gas inlet.

14. The apparatus according to claim 1, wherein the housing includes an outer peripheral wall extending between first and second end caps, and including:
at least one opening in the outer peripheral wall to access the internal cavity; and
a cap that is selectively attachable to the housing to cover the at least one opening.

15. An apparatus comprising:
a housing defining an internal cavity, wherein the housing includes at least a first exhaust gas inlet for exhaust gas at a first temperature and a second exhaust gas inlet for exhaust gas at a second temperature greater than the first temperature, and wherein the housing includes at least a first outlet to atmosphere, a second outlet to at least one storage component, and a third outlet to a cooling source;
a plurality of heating elements positioned within the internal cavity;
adsorption material located within the internal cavity and in contact with the plurality of heating elements;
at least one flow guide to direct exhaust gas through the adsorption material from the first exhaust gas inlet to the first outlet; and
a controller that is configured to operate amongst a plurality of modes comprising at least:
a first mode wherein exhaust gas flows from the first exhaust gas inlet, through the adsorption material to collect CO₂, and then out the first outlet; and
a second mode wherein the plurality of heating elements are heated via a heat source to heat the adsorption material to extract CO₂ from the adsorption material, and wherein the CO₂ is directed through the second outlet to the at least one storage component.

16. The apparatus according to claim 15, wherein:
the second exhaust gas inlet, the second outlet, and the third outlet are closed during the first mode; and
the first exhaust gas inlet and the first outlet are closed during the second mode.

17. The apparatus according to claim 15, including at least one heater selectively activated during the second mode to heat exhaust gas prior to entering the housing via the second exhaust gas inlet.

18. The apparatus according to claim 15, wherein the plurality of heating elements comprise a plurality of tubes, and wherein the heat source comprises exhaust gas flowing from the second exhaust gas inlet, through the plurality of tubes, and out the third outlet while the CO₂ is extracted from the adsorption material and directed to the second outlet.

19. The apparatus according to claim 15, wherein the at least one flow guide comprises a first flow guide and a second flow guide separate from the first flow guide, and wherein:
the first flow guide comprises a curved outer surface spaced apart from and facing the first exhaust gas inlet, the curved outer surface directing exhaust gas flow outwardly toward an inner surface of the housing and into the adsorption material; and
the second flow guide comprises a curved outer surface spaced apart from and facing the first outlet, the curved outer surface directing exhaust gas flow outwardly away from the adsorption material and toward the first outlet.

20. A method comprising:
operating a carbon capture system that is operable between at least a first mode and a second mode;
when operating in the first mode, directing cooled exhaust gas through adsorption material located within an internal cavity of housing to collect CO₂ prior to exhaust gas exiting to atmosphere; and
when operating in the second mode, heating the adsorption material via an exhaust gas heat source to extract CO₂ from the adsorption material, directing the CO₂ to at least one storage component, and directing exhaust gas out of the housing to another circuit.
